(19) United States
(12) Patent Application Publication
(10) Pub. No.: US 2017/0017449 A1
(43) Pub. Date: Jan. 19, 2017

(54) IMAGE FORMING APPARATUS, SERVER, AND NON-TRANSITORY COMPUTER READABLE MEDIUM

(71) Applicant: FUJI XEROX Co., Ltd., Tokyo (JP)

(72) Inventors: Tsutomu UDAKA, Kanagawa (JP); Atsushi KITAGAWARA, Kanagawa (JP); Fumihiko OGASAWARA, Kanagawa (JP); Tomoyuki MITSUHASHI, Kanagawa (JP)

(73) Assignee: FUJI XEROX Co., Ltd., Tokyo (JP)

(21) Appl. No.: 15/007,713

(22) Filed: Jan. 27, 2016

(30) Foreign Application Priority Data
Jul. 14, 2015 (JP) 2015-140432

(51) Int. Cl. G06F 3/12; G06F 3/048; H04N 1/00

(52) U.S. Cl. CPC G06F 3/1293; H04N 1/00477; H04N 1/00244; G06F 3/048; H04N 1/00015; H04N 1/00037; H04N 1/00082; H04N 2201/0094

(57) ABSTRACT

An image forming apparatus includes multiple parts and a drive controller. The multiple parts are used to implement an image forming operation. The drive controller exerts control in such a manner that parts, each of the parts being possibly an abnormal-noise source, among the multiple parts are sequentially driven in predetermined order in an operating state for specifying a position at which abnormal noise is produced.

### CROSS-REFERENCE TO RELATED APPLICATIONS

This application is based on and claims priority under 35 USC 119 from Japanese Patent Application No. 2015-140432 filed Jul. 14, 2015.

### BACKGROUND

### Technical Field

The present invention relates to an image forming apparatus, a server, and a non-transitory computer readable medium.

### SUMMARY

According to an aspect of the invention, there is provided an image forming apparatus including multiple parts and a drive controller. The multiple parts are used to implement an image forming operation. The drive controller exerts control in such a manner that parts, each of the parts being possibly an abnormal-noise source, among the multiple parts are sequentially driven in predetermined order in an operating state for specifying a position at which abnormal noise is produced.

### BRIEF DESCRIPTION OF THE DRAWINGS

Exemplary embodiment of the present invention will be described in detail based on the following figures, wherein:

FIG. 1 is a diagram illustrating the configuration of an image forming system according to an exemplary embodiment of the present invention;

FIG. 2 is a block diagram illustrating an exemplary configuration of an image forming apparatus according to the exemplary embodiment of the present invention;

FIG. 3 is a block diagram illustrating the hardware configuration of a controller of the image forming apparatus according to the exemplary embodiment of the present invention;

FIG. 4 is a block diagram illustrating the functional configuration of the controller of the image forming apparatus according to the exemplary embodiment of the present invention;

FIG. 5 is a diagram for describing exemplary order of parts driven in the all-parts continuously-driving mode;

FIG. 6 is a diagram for describing exemplary order of parts driven in the separately-driving mode;

FIG. 7 is a diagram illustrating an exemplary screen displayed on an operation panel of the image forming apparatus when an operation of checking abnormal noise is being performed;

FIGS. 8A and 8B are diagrams for describing an operation performed when an abnormal-noise occurrence recognition button is operated during driving of a part;

FIG. 9 is a diagram illustrating an exemplary screen displayed in the case where information such as the name of a part which is being driven is displayed on a tablet terminal;

FIG. 10 is a diagram illustrating an exemplary case in which an instruction from a management server causes the order of driving of parts to be changed;

FIGS. 11A and 11B are diagrams for describing a state occurring when the order of driving of parts is made different depending on whether or not an area in which the image forming apparatus is installed is a high-temperature and high-humidity area; and

FIG. 12 is a diagram illustrating an exemplary case in which the driving order is changed on the basis of the accumulated number of printed sheets.

### DETAILED DESCRIPTION

An exemplary embodiment of the present invention will be described in detail with reference to the drawings.

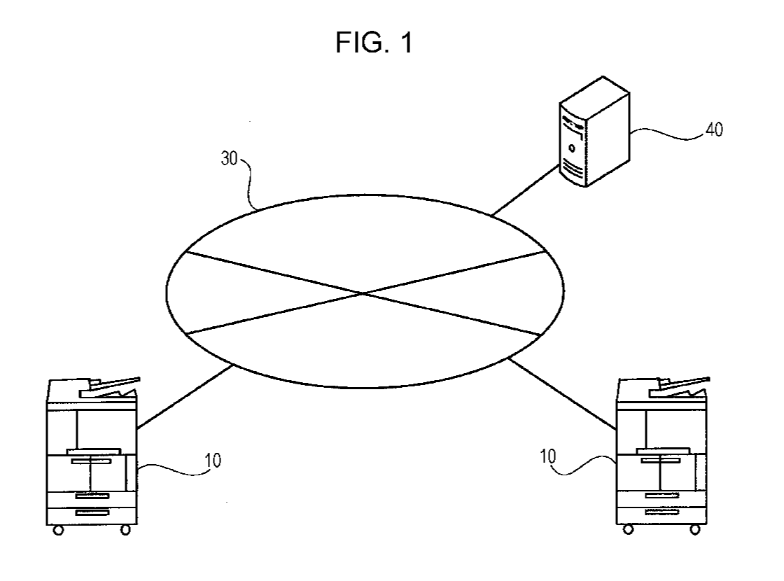

FIG. 1 is a diagram illustrating the configuration of an image forming system according to an exemplary embodiment of the present invention.

As illustrated in FIG. 1, the image forming system according to the exemplary embodiment includes multiple image forming apparatuses 10 and a management server 40 which are connected to each other over a network 30. Each of the image forming apparatuses 10 receives input print data, and outputs an image according to the print data on a sheet of paper. The image forming apparatus 10 is an apparatus which is called a so-called multi-function device having multiple functions, such as a print function, a scan function, a copy function, and a facsimile function.

The management server 40 receives information about a part producing abnormal noise, from an image forming apparatus 10, generates a list of parts having a high frequency of occurrence of abnormal noise, on the basis of the received information about a part producing abnormal noise, and manages the list. Operations performed by the management server 40 will be described in detail below.

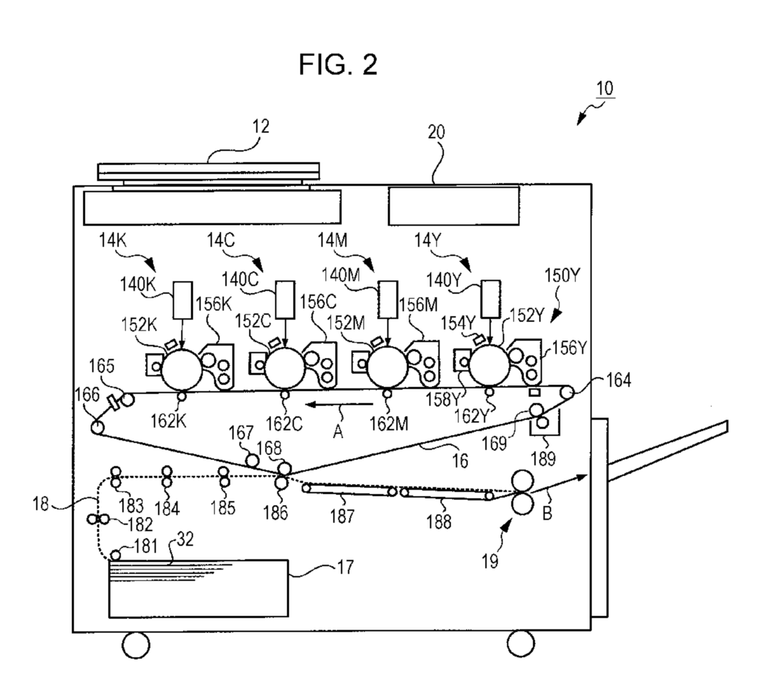

The configuration of an image forming apparatus 10 in FIG. 1 will be described by referring to FIG. 2. FIG. 2 is a schematic diagram for describing an exemplary configuration of the image forming apparatus 10, and illustrates an outside shape different from that of the image forming apparatus 10 illustrated in FIG. 1.

As illustrated in FIG. 2, the image forming apparatus 10 includes an image reading apparatus 12, image forming units 14K, 14C, 14M, and 14Y, an intermediate transfer belt 16, a paper tray 17, a paper conveying path 18, a fixing device 19, and a controller 20. The image forming apparatus 10 may be a multi-function device provided with a function serving as a full-color copier using the image reading apparatus 12, and a function serving as a facsimile, as well as a print function of printing image data received, for example, from a personal computer (not illustrated).

The outline of the image forming apparatus 10 will be described. The image reading apparatus 12 and the controller 20 are disposed in an upper portion of the image forming apparatus 10, and function as an input unit for inputting image data. The image reading apparatus 12 reads an image displayed on a document, and outputs the read image to the controller 20. The controller 20 performs image processing, such as gradation correction and resolution correction, on the image data received from the image reading apparatus 12 or image data received from a personal computer (not illustrated) or the like via a network line such as a local-area network (LAN), and outputs the resulting data to the image forming units 14.

The four image forming units 14K, 14C, 14M, and 14Y corresponding to the colors in each of which a color image is formed are disposed below the image reading apparatus 12. In the exemplary embodiment, the four image forming units 14K, 14C, 14M, and 14Y corresponding to the colors, black (K), cyan (C), magenta (M), and yellow (Y), are disposed in the horizontal direction in such a manner as to be spaced apart from each other along the intermediate transfer belt 16 at certain intervals. The intermediate transfer belt 16 which serves as an intermediate transfer body rotates in the direction indicated by an arrow A illustrated in FIG. 2. The four image forming units 14K, 14Y, 14M, and 14C sequentially forms color toner images on the basis of the image data received from the controller 20. At timings at which these toner images are to be superimposed on one another, the toner images are transferred onto the intermediate transfer belt 16 (first transfer). The order of colors of the image forming units 14K, 14C, 14M, and 14Y is not limited to the order of black (K), cyan (C), magenta (M), and yellow (Y). The order is any, such as the order of yellow (Y), magenta (M), cyan (C), and black (K).

The paper conveying path 18 is disposed under the intermediate transfer belt 16. Recording paper 32 supplied from the paper tray 17 is conveyed along the paper conveying path 18. The color toner images which have been transferred onto the intermediate transfer belt 16 in such a manner that the toner images are superimposed on one another are transferred onto the recording paper 32 (second transfer) at a time. The transferred toner image is fixed by the fixing device 19, and is discharged to the outside in the direction indicated by an arrow B.

The configurations of units of the image forming apparatus 10 will be described in detail.

The controller 20 performs predetermined image processing, such as shading correction, correction of misalignment of a document, brightness/color-space conversion, gamma correction, frame erasing, and color/movement editing, on the image data obtained through a reading operation using the image reading apparatus 12. An optical color image of a document which is read by the image reading apparatus 12 is, for example, document reflectivity data of three colors, red (R), green (G), and blue (B) (8 bits for each color), and is converted into document color gradation data of four colors, black (K), cyan (C), magenta (M), and yellow (Y), (8 bits for each color) through image processing performed by the controller 20.

The image forming units 14K, 14C, 14M, and 14Y (image forming sections) are disposed parallel with each other in such a manner as to be spaced apart at certain intervals in the horizontal direction, and have a substantially similar configuration except that different colors in which images are formed are used. Therefore, in the description below, the image forming unit 14K will be described. The configurations of the image forming units 14 are differentiated from one another by attaching K, C, M, or Y to a reference numeral.

The image forming unit 14K includes an optical scanning device 140K which performs scanning with laser light in accordance with image data received from the controller 20, and an image forming device 150K with which an electrostatic latent image is formed by the laser light used in scanning performed by the optical scanning device 140K.

The optical scanning device 140K modulates laser light in accordance with image data of black (K). This laser light is emitted onto a photoconductor drum 152K of the image forming device 150K.

The image forming device 150K includes the photoconductor drum 152K which rotates at a predetermined rotation speed in the direction indicated by the arrow A, a charging device 154K serving as a charging section which uniformly charges the surface of the photoconductor drum 152K, a developing device 156K which develops an electrostatic latent image formed on the photoconductor drum 152K, and a cleaning device 158K. The photoconductor drum 152K is a cylindrically-shaped image carrier which holds a developer image such as a toner image. The photoconductor drum 152K is uniformly charged by the charging device 154K, and an electrostatic latent image is formed by using laser light emitted by the optical scanning device 140K. The electrostatic latent image formed on the photoconductor drum 152K is developed by using a developer such as black (K) toner by the developing device 156K, and is transferred onto the intermediate transfer belt 16. Residual toner, paper dust, and the like which are attached to the photoconductor drum 152K after the process of transferring the toner image (developer image) are removed by the cleaning device 158K.

Similarly, the other image forming units 14C, 14M, and 14Y which include photoconductor drums 152C, 152M, and 152Y, and developing devices 156C, 156M, and 156Y, respectively, form color toner images in cyan (C), magenta (M), and yellow (Y), which are transferred onto the intermediate transfer belt 16.

The intermediate transfer belt 16 is wound at a certain tension around a drive roll 164, idle rolls 165, 166, and 167, a backup roll 168, and an idle roll 169. A drive motor (not illustrated) rotates the drive roll 164, whereby the intermediate transfer belt 16 is driven so as to rotate at a predetermined speed in the direction indicated by the arrow A. The intermediate transfer belt 16 is formed as an endless belt, for example, by forming a belt by using synthetic resin film such as a polyimide having flexibility and connecting the ends of the belt-shaped synthetic resin film through welding or the like.

On the intermediate transfer belt 16, first transfer rolls 162K, 162C, 162M, and 162Y are disposed at positions so as to face the image forming units 14K, 14C, 14M, and 14Y, respectively. These first transfer rolls 162 are used to transfer the color toner images which are formed on the photoconductor drums 152K, 152C, 152M, and 152Y onto the intermediate transfer belt 16 in such a manner that the toner images are superimposed on one another. Residual toner attached to the intermediate transfer belt 16 is removed by using a cleaning blade or brush of a belt cleaning device 189 provided downstream of the position at which second transfer is performed (second-transfer position).

On the paper conveying path 18, a paper feeding roll 181 which pulls out the recording paper 32 from the paper tray 17, pairs of rolls for conveying paper, a first pair of rolls 182, a second pair of rolls 183, and a third pair of rolls 184, and registration rolls 185 which convey the recording paper 32 at a predetermined timing to the second-transfer position are disposed.

At the second-transfer position on the paper conveying path 18, a second transfer roll 186 pressed against the backup roll 168 is disposed. By using the contact pressure and an electrostatic force of the second transfer roll 186, the color toner images which are transferred onto the intermediate transfer belt 16 in such a manner as to be superimposed on one another are secondarily transferred onto the recording paper 32. The recording paper 32 on which the color toner images are transferred is conveyed to the fixing device 19 by using conveyance belts 187 and 188.

The fixing device 19 heats and presses the recording paper 32 onto which the color toner images are transferred, thereby melting and fixing toner on the recording paper 32.

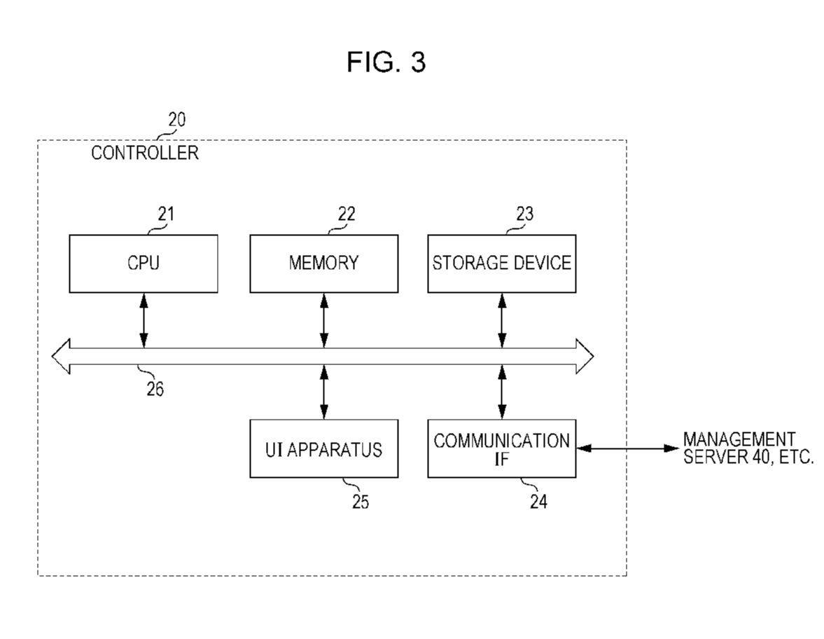

FIG. 3 is a diagram illustrating the hardware configuration of the controller 20 illustrated in FIG. 2.

As illustrated in FIG. 3, the controller 20 includes a CPU 21, a memory 22, a storage device 23 such as a hard disk drive (HDD), a communication interface (IF) 24 which receives/transmits data from/to an external apparatus such as the management server 40 via the network 30, and a user interface (UI) apparatus 25 including a touch panel or a liquid-crystal display, and a keyboard. These components are connected to one another via a control bus 26.

The CPU 21 performs predetermined processes on the basis of control programs stored in the memory 22 or the storage device 23, and controls operations performed by the image forming apparatus 10. In the exemplary embodiment, the description is made in which the CPU 21 reads control programs stored in the memory 22 or the storage device 23 and executes the programs. The programs which are stored in a storage medium such as a compact disc-read-only memory (CD-ROM) may be provided to the CPU 21.

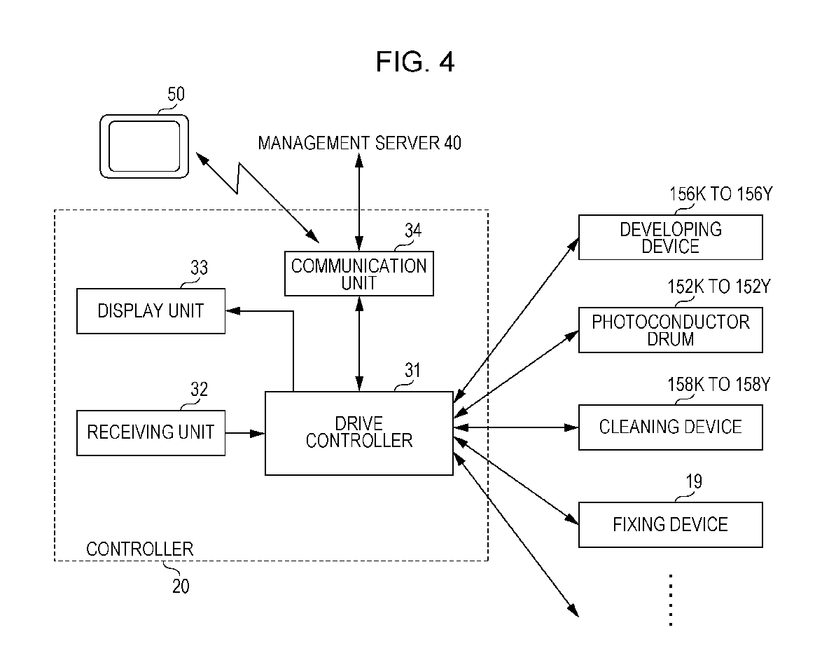

FIG. 4 is a block diagram illustrating the functional configuration of the controller 20 which is implemented by executing the above-described control programs.

As illustrated in FIG. 4, the controller 20 according to the exemplary embodiment includes a drive controller 31, a receiving unit 32, a display unit 33, and a communication unit 34.

The drive controller 31 controls driving of multiple parts for achieving an image forming operation, such as the developing devices 156K to 156Y, the photoconductor drums 152K to 152Y, the cleaning devices 158K to 158Y, and the fixing device 19.

The controller 20 has the diagnostic mode for specifying a position at which a malfunction occurs, and determining the reason, in addition to the normal operating mode for outputting an image onto paper. The diagnostic mode includes the abnormal-noise check operating mode which is an operating mode (operating state) for, when abnormal noise is produced in the image forming apparatus 10, specifying the position at which the abnormal noise is produced.

In the abnormal-noise check operating mode for specifying a position at which abnormal noise is produced, the drive controller 31 exerts control so that parts which may be an abnormal-noise source, among the multiple parts for achieving the image forming operation are sequentially driven in predetermined order (sequence).

For example, the drive controller 31 drives a certain part alone for five seconds. After an interval time (stop time) of a few seconds, the drive controller 31 drives another part alone for five seconds. In this manner, the drive controller 31 sequentially drives each of the multiple parts alone.

While each of the parts is driven to check whether or not occurrence of abnormal noise is present, the receiving unit 32 receives an instruction to stop the driving from a user.

The display unit 33 displays information, such as the name of a part which is being driven by the drive controller 31, and the driving mode which is being performed.

The display unit 33 displays operational information for performing an operation of addressing abnormal noise, on a part which has been being driven when the receiving unit 32 has received an instruction to stop the driving, on the operation panel or the like.

The communication unit 34 receives/transmits data from/to the management server 4 via the network 30, and communicates with a mobile terminal, such as a tablet terminal 50 or a smartphone. The communication unit 34 receives/transmits data from/to a mobile terminal through wireless communication performed by using radio waves or the like. Alternatively, the communication unit 34 may receive/transmit data from/to a mobile terminal by using an optical signal or a voice signal.

In the abnormal-noise check operating mode, the drive controller 31 may perform the mode by selecting the all-parts continuously-driving mode or the separately-driving mode and switching between these modes. The all-parts continuously-driving mode is a mode in which all of the parts which may be an abnormal-noise source, among the multiple parts are sequentially driven in predetermined order. The separately-driving mode is a mode in which some of the parts which may be an abnormal-noise source, among the multiple parts are sequentially driven in predetermined order.

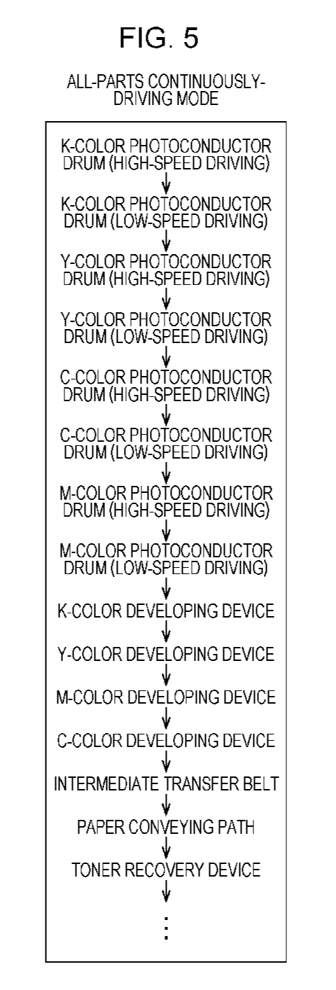

FIG. 5 illustrates exemplary order of driving of the parts included in the image forming apparatus 10 in the all-parts continuously-driving mode.

The order in which the drive controller 31 drives parts which may be an abnormal-noise source, in the all-parts continuously-driving mode is the descending order of frequency of occurrence of abnormal noise which is based on past history information. That is, setting is made so that a part having a high frequency of occurrence of abnormal noise in the past history information is placed high in the order.

In the exemplary order illustrated in FIG. 5, the parts are sequentially driven. The illustrated example is as follows. The photoconductor drum 152K for K color is first subjected to high-speed driving, and the photoconductor drum 152K for K color is then subjected to low-speed driving. After that, the photoconductor drum 152Y for Y color is subjected to high-speed driving.

A driving speed of each part is set to a driving speed which most likely causes abnormal noise to be easily produced from a structural viewpoint. However, even in the same part, there may be abnormal noise which is easily produced when the part is driven at a high speed, and abnormal noise which is easily produced when the part is driven at a low speed. For such a part, two types of driving speeds, such as high-speed driving and low-speed driving, are set for the same part.

For example, in the example illustrated in FIG. 5, modes in which driving is performed at two types of speeds, high-speed driving and low-speed driving, are provided for the photoconductor drums.

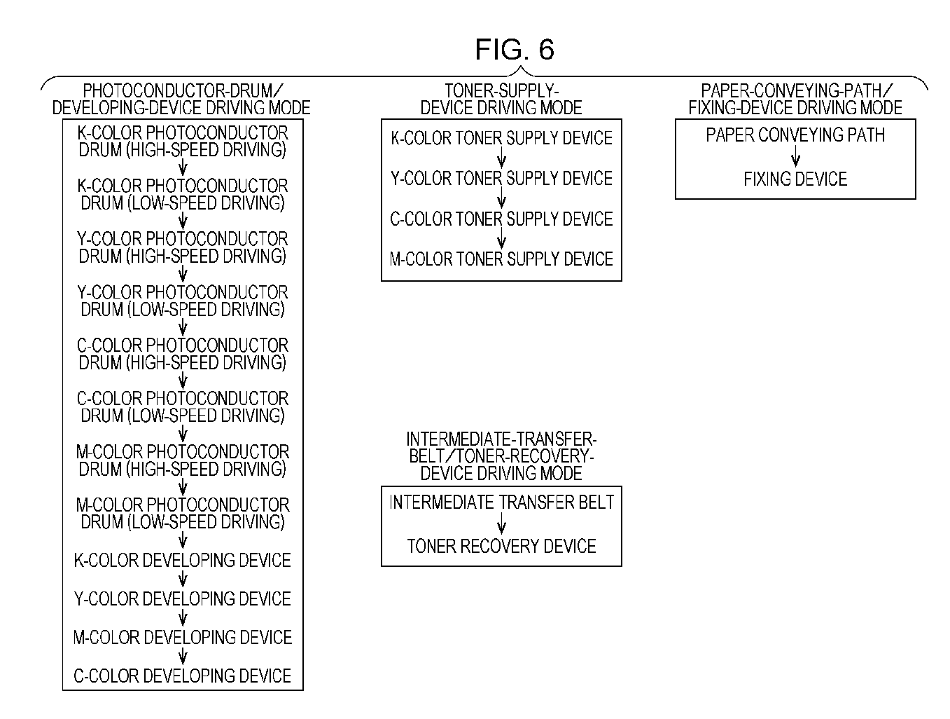

FIG. 6 illustrates an exemplary case in which parts which may be an abnormal-noise source are grouped in the separately-driving mode.

In the example in the separately-driving mode which is illustrated in FIG. 6, for example, the photoconductor-drum/developing-device driving mode is an operating mode in which only the photoconductor drums and the developing devices for the colors are sequentially driven. The toner-supply-device driving mode is an operating mode in which only the toner supply devices for the colors are sequentially driven.

In the separately-driving mode, which parts are to be grouped into one driving mode is determined, for example, in consideration of where the parts are disposed in the apparatus or through which portion of the front-door opening abnormal noise of the parts is easily heard.

For example, when abnormal noise produced in the paper conveying path or abnormal noise produced when the fixing device is driven are likely to be produced on the left of the apparatus, the paper conveying path and the fixing device are grouped into the same group, and are sequentially driven in one driving mode.

This grouping operation achieves a state in which a person who checks if occurrence of abnormal noise is present does not need to perform the checking operation at various positions in the apparatus, and may perform the checking operation at the same position.

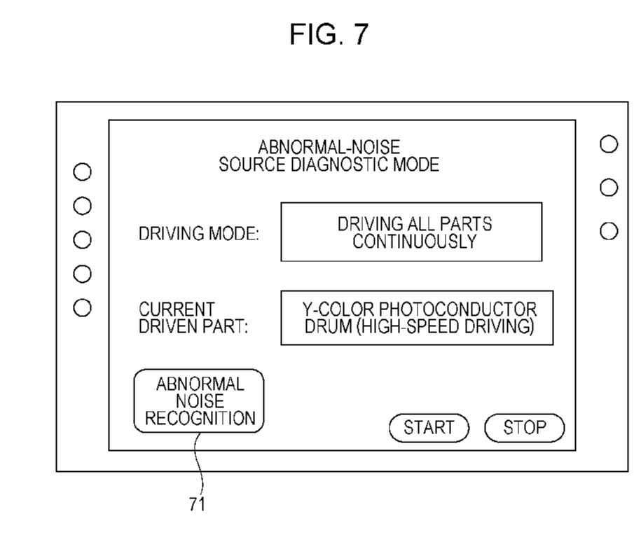

FIG. 7 illustrates an exemplary screen displayed on the operation panel of the image forming apparatus 10 when the operation of checking abnormal noise is being performed.

The exemplary screen illustrated in FIG. 7 shows that the all-parts continuously-driving mode has been selected as the driving mode, and is being performed, and that the part which is being driven is the “photoconductor drum for Y color” on which high-speed driving is being performed.

In the exemplary screen, an abnormal-noise occurrence recognition button 71 is displayed on the touch panel. When a user who is checking abnormal noise recognizes occurrence of abnormal noise while a certain part is being driven, the user operates the abnormal-noise occurrence recognition button 71 so as to stop the driving of the part.

That is, when the abnormal-noise occurrence recognition button 71 is operated, the receiving unit 32 receives an instruction to stop the driving from the user, and the drive controller 31 stops the part which is being driven, because the receiving unit 32 receives an instruction to stop the driving.

Unnecessary driving of normal parts after a part which is an abnormal-noise source is specified may cause the life of the parts to be shortened, or may cause the parts to be damaged through driving, whereby a secondary problem may arise. Therefore, when the part which is an abnormal-noise source is specified, parts which are to be driven after that are desirably not driven as long as possible.

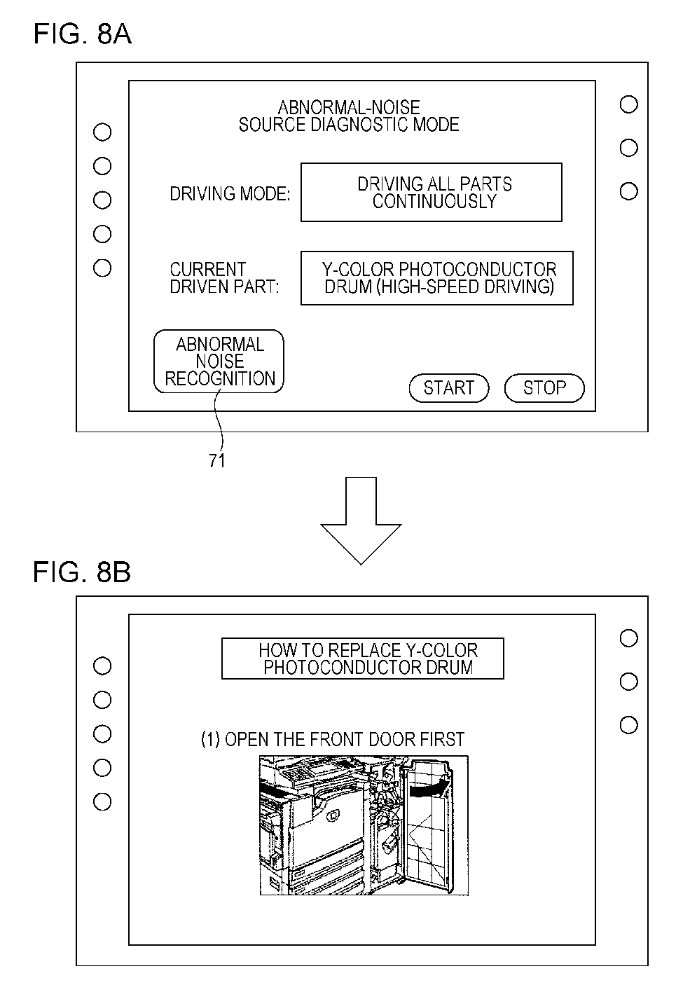

As illustrated in FIG. 8A, the abnormal-noise occurrence recognition button 71 is operated while the photoconductor drum for Y color is being driven. Then, as illustrated in FIG. 8B, operational information for performing an operation of addressing abnormal noise, on the photoconductor drum for Y color which has been being driven when the abnormal-noise occurrence recognition button 71 has been operated is displayed on the operation panel.

The operational information for addressing abnormal noise is information about operations for reducing abnormal noise, and is information for describing, for example, an operational method for applying oil to the part from which abnormal noise is recognized, or an replacement method for replacing the part from which abnormal noise is recognized with a new part.

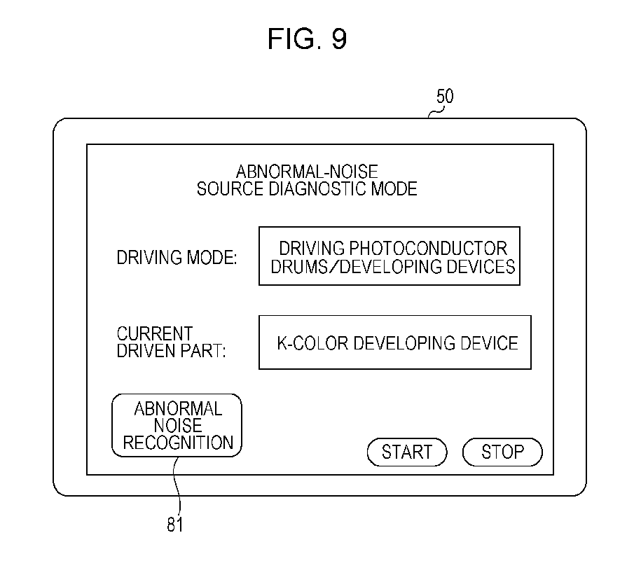

FIG. 9 illustrates an exemplary case in which such display information is displayed on the tablet terminal 50.

In the exemplary screen illustrated in FIG. 9, information similar to that displayed on the operation panel of the image forming apparatus 10 is displayed. The name of a part which is being driven and an abnormal-noise occurrence recognition button 81 which is to be pressed when occurrence of abnormal noise is recognized are displayed.

Thus, in order to display a part which is being driven and the like on the tablet terminal 50, the drive controller 31 transmits information indicating the part which is being driven, via the communication unit 34 to the tablet terminal 50. When an instruction to stop the driving operation is transmitted from the tablet terminal 50 via the communication unit 34, the drive controller 31 stops the part which is being driven, and transmits operational information for performing an operation of addressing abnormal noise, on the part which has been being driven when the instruction to stop the driving has been received, to the tablet terminal 50.

Then, similarly to the exemplary screen illustrated in FIG. 8B, the procedure for replacing the part producing abnormal noise or a procedure for applying oil is displayed on the tablet terminal 50.

The order of driving of parts which may be an abnormal-noise source, in each driving mode does not need to be fixed in the initial state, and the driving order may be changed in accordance with various operations and information.

For example, when the drive controller 31 receives an instruction to stop driving of the part which is being driven, the drive controller 31 may transmit information about the part which has been being driven when the instruction to stop driving has been received, to the management server 40 which is an external apparatus, and may change the order of driving of parts which may be an abnormal-noise source, on the basis of an instruction from the management server 40.

In this case, when the management server 40 receives information about the part producing abnormal noise, from the image forming apparatus 10, the management server 40 creates a list of parts having a high frequency of occurrence of abnormal noise, on the basis of the received information about the part producing abnormal noise, and transmits an instruction to change the order of driving of parts which may be an abnormal-noise source, to the image forming apparatus 10 so that a part having a high frequency of occurrence of abnormal noise is placed high in the order.

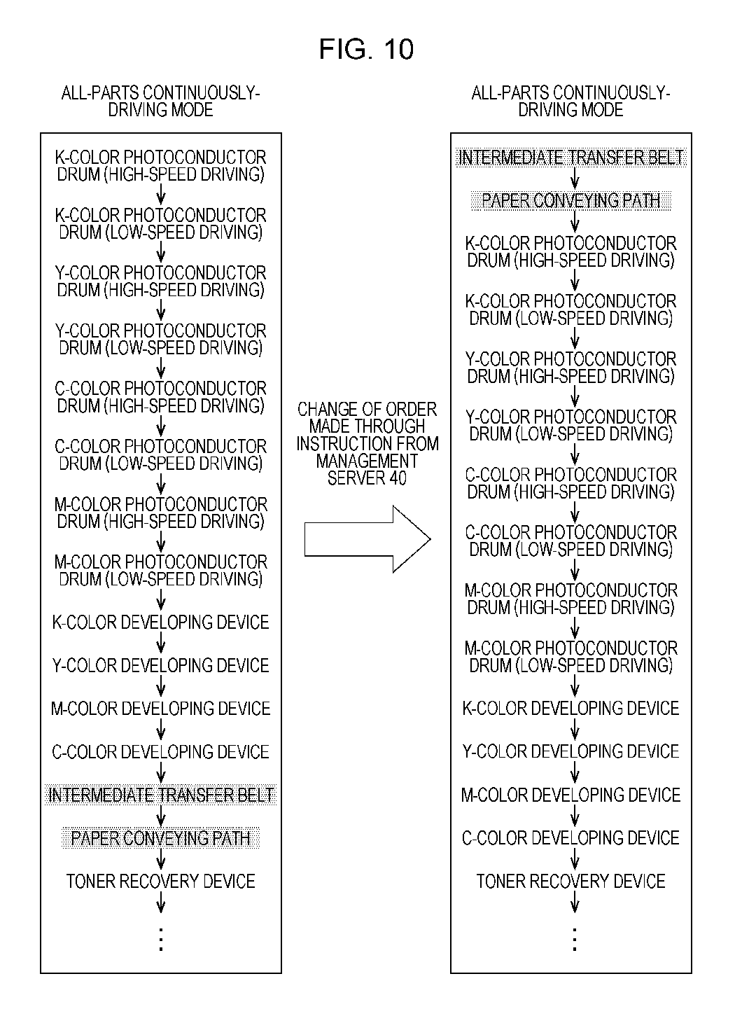

FIG. 10 illustrates an exemplary case in which the driving order of parts is thus changed through the instruction from the management server 40.

The example illustrated in FIG. 10 shows the following case. The frequencies of abnormal-noise occurrence of the “intermediate transfer belt” and the “paper conveying path” are high. Therefore, the management server 40 transmits an instruction to place these parts high in the driving order, to the image forming apparatuses 10.

Therefore, in the example illustrated in FIG. 10, a change is made so that the “intermediate transfer belt” and the “paper conveying path” are placed high in the driving order.

Thus, the management server 40 collects information about parts producing abnormal noise, from each of the image forming apparatuses 10, and the driving order in the other image forming apparatuses 10 is changed on the basis of the instruction from the management server 40. Accordingly, even when unexpected abnormal noise troubles intensively occur in a certain part due to a defect in the part, defective processing, defective assembly, defective inspection, or the like in manufacture, a change is automatically made so that the part is placed high in the driving order.

Abnormal noise encompasses various types of sound, such as a sound which is likely to be produced in a cool-temperature environment, and a sound which is likely to be produced in a high-temperature and high-humidity environment. Therefore, the types of parts having a high probability of occurrence of abnormal noise are changed depending on the installation environment of the image forming apparatus 10. Therefore, in creation of a list of the frequencies of occurrence based on the information that is information about a part producing abnormal noise and that is transmitted from each of the image forming apparatuses 10 installed in various locations, the management server 40 may create a different list depending on the condition in which the image forming apparatus 10 is installed.

For example, a temperature sensor and a humidity sensor are provided for each image forming apparatus 10. When temperature information and humidity information obtained at the installation position as well as information about a part producing abnormal noise are transmitted to the management server 40, the management server 40 separately creates a list of the frequencies of abnormal-noise occurrence in an image forming apparatus 10 installed in a high-temperature and high-humidity area, and a list of frequencies of abnormal-noise occurrence in an image forming apparatus 10 installed in an area other than the high-temperature and high-humidity area.

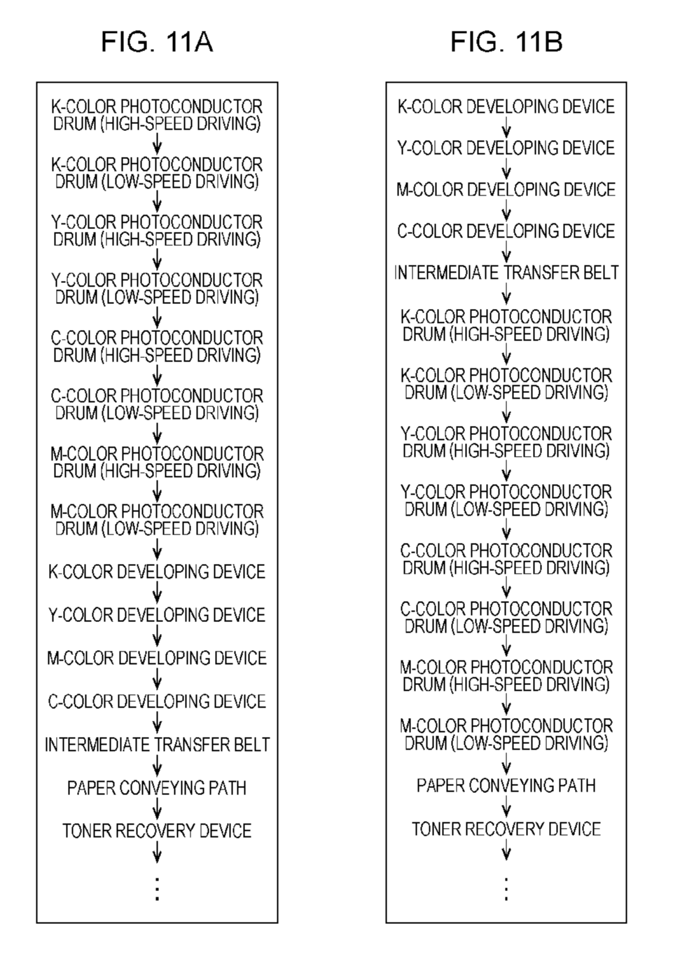

The management server 40 transmits an instruction to change the driving order for each of the areas in which the image forming apparatuses 10 are installed, whereby, as illustrated in FIGS. 11A and 11B, the driving order of parts is different depending on whether or not the installation area is a high-temperature and high-humidity area.

That is, for an image forming apparatus 10 installed in an area other than the high-temperature and high-humidity area, driving order of parts in the all-parts continuously-driving mode is set as illustrated in FIG. 11A. In contrast, for an image forming apparatus 10 installed in a high-temperature and high-humidity area, driving order of parts in the all-parts continuously-driving mode is set as illustrated in FIG. 11B.

In the examples illustrated in FIGS. 11A and 11B, since the frequencies of abnormal-noise occurrence in the developing devices for the colors are found to be high in an image forming apparatus 10 installed in a high-temperature and high-humidity area, a change is made so that the developing devices are placed high in the driving order in the image forming apparatus 10 installed in a high-temperature and high-humidity area.

Further, the management server 40 which receives information about a part producing abnormal noise, from an image forming apparatus 10 may automatically make arrangements for delivering a replacement part for addressing abnormal noise which has been produced, or may automatically make arrangements for visit of a customer engineer (CE) who addresses abnormal noise.

The case in which the drive controller 31 changes the order of parts to be driven when occurrence of abnormal noise is checked, on the basis of the instruction from the management server 40 is described above. Alternatively, the driving order may be changed without receiving the instruction from the management server 40.

For example, the drive controller 31 may change the order of driving of parts which may be an abnormal-noise source, on the basis of the accumulated number of printed sheets.

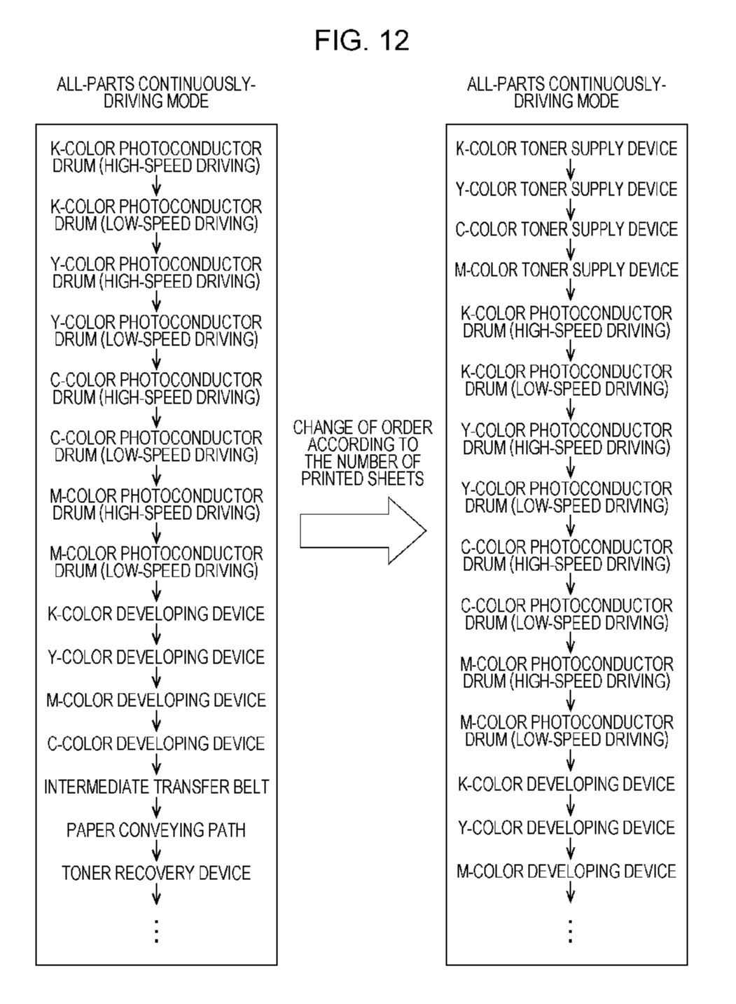

FIG. 12 illustrates an exemplary case in which the driving order is thus changed on the basis of the accumulated number of printed sheets.

The reason why the driving order is thus changed in accordance with the number of printed sheets is that a large number of printed sheets increase the frequency of abnormal-noise occurrence in a certain part due to wearing.

For example, when the accumulated number of printed sheets exceeds 30000, the driving order is changed in the driving mode so that the toner supply devices are placed high in the driving order as illustrated in FIG. 12.

Accordingly, parts having a high frequency of abnormal-noise occurrence are placed high in the driving order, resulting in reduction in a probability of driving normal parts unnecessarily and reduction in time until a part which is an abnormal-noise source is specified.

When a part which may be an abnormal-noise source is replaced, the drive controller 31 may change the order of driving of parts which may be an abnormal-noise source, in such a manner that the replaced part is placed low in the order.

That is, replacement of a part causes the probability of abnormal-noise occurrence of the part to be substantially decreased. Therefore, a change is made so that the part is placed low in the driving order.

The replacement of a part may be detected, for example, by using a customer replaceable unit memory (CRUM) tag provided for a replaceable part. The CRUM tag is a nonvolatile memory in which identification information or the like with which each part may be specified is stored. The image forming apparatus 10 may read information in the CRUM tag so as to grasp replacement of the part.

Further, the drive controller 31 may change the drive time for which each part is driven, and the interval time (stop time) which is a time after driving of a certain part is stopped until driving of the next part is started, in a predetermined range on the basis of an instruction which is input from a user.

In this case, the drive time for each part is determined in consideration of the delicateness of the part, the degree in which a secondary problem occurring due to driving is likely to arise, and the like.

For example, after a toner supply device is driven for a long time, a malfunction such as an output image having a high density may occur. When a photoconductor drum is driven too long, a malfunction, such as blade curling or a streak in an output image, may occur.

Therefore, for the settable range for the drive time, the upper limit may be set in accordance with these characteristics of each part. Further, for the interval time, the minimum time necessary to switch operations of each part may be set as the lower limit.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of parts that are used to implement an image forming operation; and
a drive controller that exerts control in such a manner that parts, each of the parts being possibly an abnormal-noise source, among the plurality of parts are sequentially driven in predetermined order in an operating state for specifying a position at which abnormal noise is produced.

2. The image forming apparatus according to claim 1,
wherein the drive controller exerts control by switching between two types of control, one of the two types of control being control in which all of the parts, each of the parts being possibly an abnormal-noise source, among the plurality of parts are sequentially driven in the predetermined order, the other of the two types of control being control in which some of the parts, each of the parts being possibly an abnormal-noise source, among the plurality of parts are sequentially driven in the predetermined order.

3. The image forming apparatus according to claim 1,
wherein the order in which the parts, each of the parts being possibly an abnormal-noise source, are driven by the drive controller is descending order of frequency of occurrence of abnormal noise based on past history information.

4. The image forming apparatus according to claim 2,
wherein the order in which the parts, each of the parts being possibly an abnormal-noise source, are driven by the drive controller is descending order of frequency of occurrence of abnormal noise based on past history information.

5. The image forming apparatus according to claim 1, further comprising:
a communication unit that communicates with a mobile terminal,
wherein the drive controller transmits information indicating a part that is being driven, via the communication unit to the mobile terminal, and, when an instruction to stop the driving is received from the mobile terminal via the communication unit, the drive controller stops the part which is being driven, and transmits, to the mobile terminal, operational information for performing an operation of addressing abnormal noise, on the part which has been being driven when the instruction to stop the driving has been received.

6. The image forming apparatus according to claim 1, further comprising:
an accepting unit that accepts an instruction to stop driving,
wherein, when the accepting unit accepts the instruction to stop driving, the drive controller stops the part which is being driven.

7. The image forming apparatus according to claim 6, further comprising:
a display that displays operational information for performing an operation of addressing abnormal noise, on the part which has been being driven when the accepting unit has accepted the instruction to stop driving.

8. The image forming apparatus according to claim 5,
wherein, when the instruction to stop driving of the part which is being driven is received, the drive controller transmits information about the part which has been being driven when the instruction to stop driving has been received, to an external apparatus, and changes the order on a basis of an instruction from the external apparatus, the order being order in which the parts, each of the parts being possibly an abnormal-noise source, are driven.

9. The image forming apparatus according to claim 6,
wherein, when the instruction to stop driving of the part which is being driven is received, the drive controller transmits information about the part which has been being driven when the instruction to stop driving has been received, to an external apparatus, and changes the order on a basis of an instruction from the external apparatus, the order being order in which the parts, each of the parts being possibly an abnormal-noise source, are driven.

10. The image forming apparatus according to claim 7,
wherein, when the instruction to stop driving of the part which is being driven is received, the drive controller transmits information about the part which has been being driven when the instruction to stop driving has been received, to an external apparatus, and changes the order on a basis of an instruction from the external apparatus, the order being order in which the parts, each of the parts being possibly an abnormal-noise source, are driven.

11. The image forming apparatus according to claim 1,
wherein the drive controller changes the order on a basis of the accumulated number of printed sheets, the order being order in which the parts, each of the parts being possibly an abnormal-noise source, are driven.

12. The image forming apparatus according to claim 1,
wherein, when a part which is possibly an abnormal-noise source is replaced, the drive controller changes the order in such a manner that the replaced part is placed low in the order, the order being order in which the parts, each of the parts being possibly an abnormal-noise source, are driven.

13. The image forming apparatus according to claim 1,
wherein the drive controller is capable of changing a drive time and a stop time within a predetermined range on a basis of an instruction which is input from a user, the drive time being a time for which each part is driven, the stop time being a time from a time point at which driving of a certain part is stopped to a time point at which driving of a next part in the order is started.

14. A server comprising:
a receiving unit that receives information about a part producing abnormal noise, from an image forming apparatus, the image forming apparatus exerting control so as to sequentially drive parts, each of the parts being possibly an abnormal-noise source, among a plurality of parts implementing an image forming operation, in predetermined order in an operating state for specifying a position at which abnormal noise is produced; and
a transmitting unit that creates a list of parts having a high frequency of occurrence of abnormal noise, on a basis of the information about the part producing abnormal noise, the information being received from the receiving unit, and transmits, to the image forming apparatus, an instruction to change the order in such a manner that a part having a high frequency of occurrence of abnormal noise is placed high in the order, the order being order in which the parts, each of the parts being possibly an abnormal-noise source, are driven.

15. A non-transitory computer readable medium storing a program causing a computer to execute a process comprising:
making a transition to an operating state for specifying a position at which abnormal noise is produced; and
exerting control in such a manner that parts, each of the parts being possibly an abnormal-noise source, among a plurality of parts implementing an image forming operation are sequentially driven in predetermined order in the operating state for specifying a position at which abnormal noise is produced.
